(19) United States
(12) Patent Application Publication
(10) Pub. No.: US 2025/0351104 A1
(43) Pub. Date: Nov. 13, 2025

(54) IMPLICITLY UPDATING TIMING ADVANCE IN L1/L2 MOBILITY

(71) Applicant: QUALCOMM Incorporated, San Diego, CA (US)

(72) Inventors: Fang YUAN, Beijing (CN); Yan ZHOU, San Diego, CA (US); Tao LUO, San Diego, CA (US)

(21) Appl. No.: 18/863,535

(22) PCT Filed: Aug. 5, 2022
(86) PCT No.: PCT/CN2022/110424

§ 371 Date: Nov. 6, 2024

(51) Int. Cl. H04W 56/00

(52) U.S. Cl. CPC H04W 56/003

(57) ABSTRACT

Aspects presented herein may improve the latency and efficiency of L1/L2 inter-cell mobility by providing an improved TA management for a UE. In one aspect, a UE derives a TA for a set of deactivated cells based on an Rx time difference between an active cell and the set of deactivated cells. The UE maintains the TA for the set of deactivated cells prior to an activation of the set of deactivated cells. The UE applies the TA to the set of deactivated cells or to an initial Tx to the set of deactivated cells in response to the activation of the set of deactivated cells. The set of deactivated cells may correspond to one deactivated cell or a deactivated TAG that includes multiple deactivated cells.

### TECHNICAL FIELD

The present disclosure relates generally to communication systems, and more particularly, to a wireless communication involving timing advance (TA).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), (and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus derives a timing advance (TA) for a set of deactivated cells based on a reception (Rx) time difference between an active cell and the set of deactivated cells. The apparatus maintains the TA for the set of deactivated cells prior to an activation of the set of deactivated cells. The apparatus applies the TA to the set of deactivated cells or to an initial transmission (Tx) to the set of deactivated cells in response to the activation of the set of deactivated cells.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example inter-cell mobility of a UE in accordance with various aspects of the present disclosure.

FIG. 5 is a diagram illustrating an example inter-cell mobility of a UE in accordance with various aspects of the present disclosure.

FIG. 6 is a diagram illustrating an example of a UE being handed over from one primary cell (PCell) to another candidate PCell among a pre-configured candidate PCell set in accordance with various aspects of the present disclosure.

FIG. 7 is a diagram illustrating an example of a UE deriving and maintaining a timing advance (TA) for a deactivated cell based on a reception (Rx) time difference measurement in accordance with various aspects of the present disclosure.

FIG. 8 is a diagram illustrating an example of calculating a TA for a second cell based on the TA from a first cell in accordance with various aspects of the present disclosure.

FIG. 9 is a diagram illustrating an example of a UE maintaining an ideal/target metric value for TA and/or UL transmission timing for a set of deactivated cells to ensure the quality and/or accuracy of the TA and/or the UL transmission timing derived for the set of deactivated cells are accurate within a threshold in accordance with various aspects of the present disclosure.

FIG. 10 is a flowchart of a method of wireless communication.

FIG. 11 is a flowchart of a method of wireless communication.

FIG. 12 is a diagram illustrating an example of a hardware implementation for an example apparatus and/or network entity.

### DETAILED DESCRIPTION

Aspects presented herein may improve the latency and efficiency of L1/L2 inter-cell mobility by providing an improved timing advance (TA) management for a UE. In one aspect of the present disclosure, to save or reduce the new PCell activation latency, a UE may be configured to maintain TA on a deactivated cell or a deactivated TAG, which may include a plurality of deactivated cells, such that the UE may apply the TA associated with the deactivated cell or the deactivated TAG prior to or when the deactivated cell or the deactivated TAG is activated. This may enable the UE to skip requesting/receiving a TA update/command for a new PCell after a deactivated candidate PCell is selected as the new PCell, thereby improving the latency and efficiency of L1/L2 inter-cell mobility. For example, a UE may be configured to maintain TA for a set of deactivated cells (e.g., one deactivated cell or a group of deactivated cells) without specifying any report and/or TA update/command from a serving base station, where the UE may derive the TA for a set of deactivated cell based on a reception (Rx) timing difference between an active cell and the set of deactivated cells. Then, the UE may apply the TA derived for the set of deactivated cells autonomously once the set of deactivated cells is activated. As the process of maintaining the TA for the set of deactivated cells does not specify additional signaling or reporting between the UE and the base station, the process of maintaining or updating the TA may also be referred to as a “report-less TA update.”

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

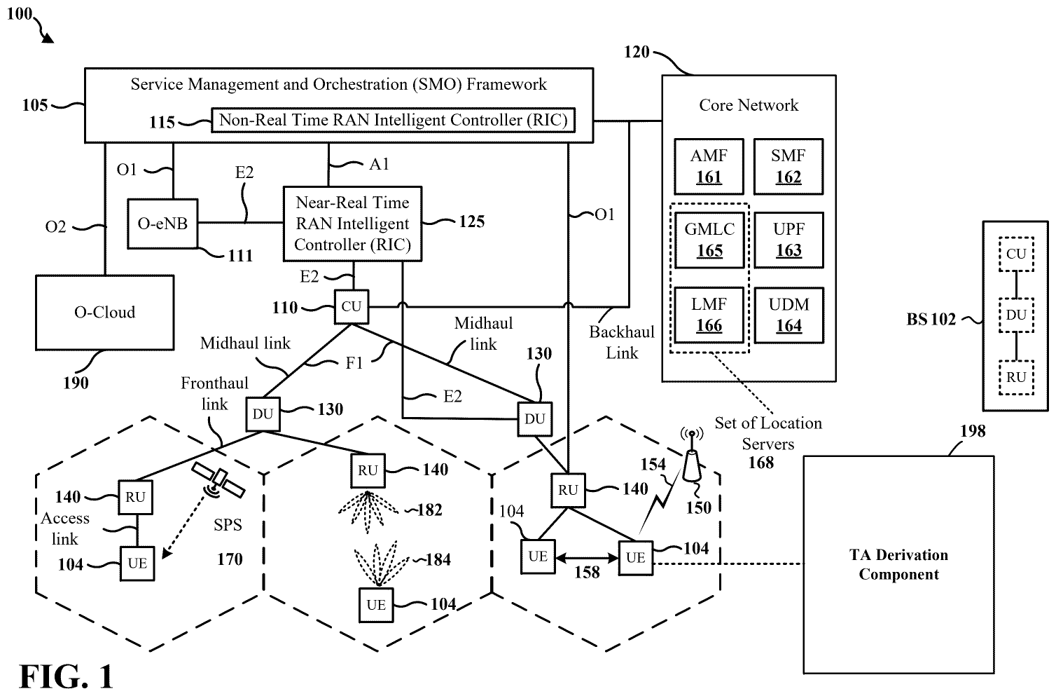

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHZ). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may be configured to derive a TA for a set of deactivated cells based on an Rx time difference between an active cell and the set of deactivated cells; maintain the TA for the set of deactivated cells prior to an activation of the set of deactivated cells; and apply the TA to the set of deactivated cells or to an initial Tx to the set of deactivated cells in response to the activation of the set of deactivated cells (e.g., via the TA derivation component 198).

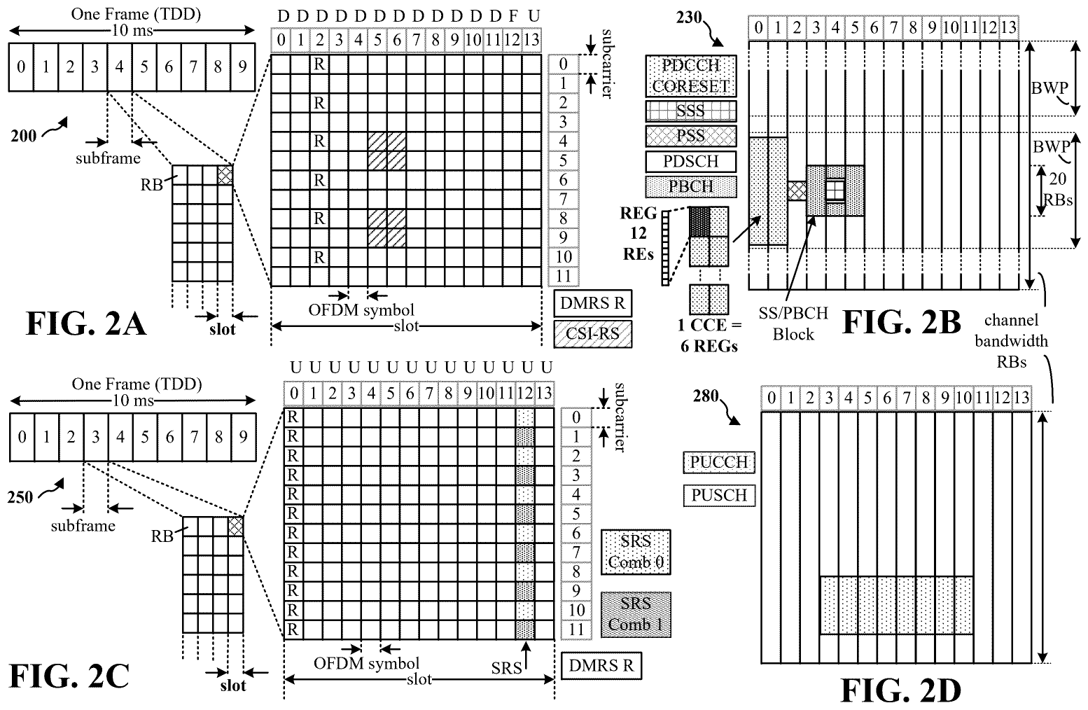

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | Cyclic |
|---|---|---|
| μ | Δf = 2^{μ} · 15[kHz] | prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

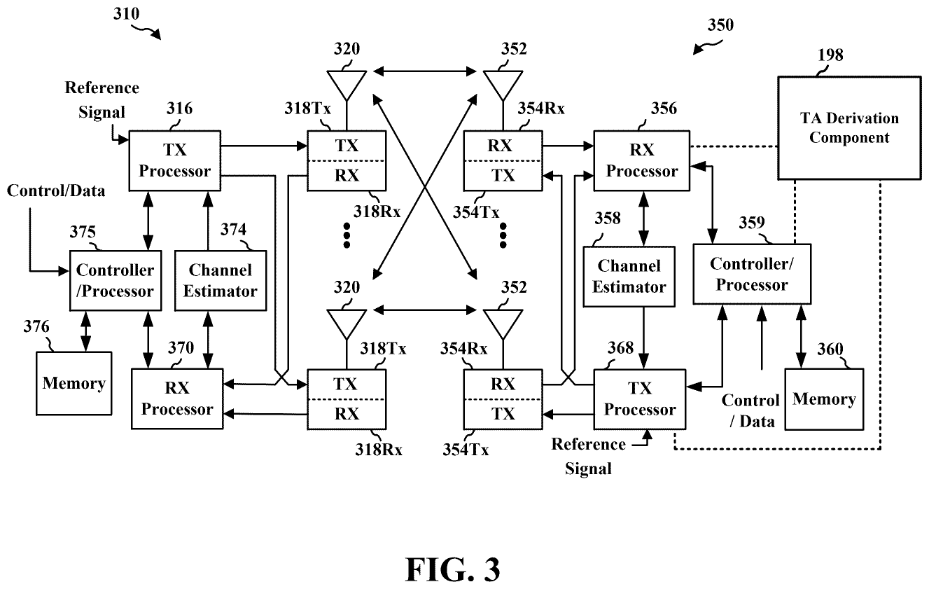

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the TA derivation component 198 of FIG. 1.

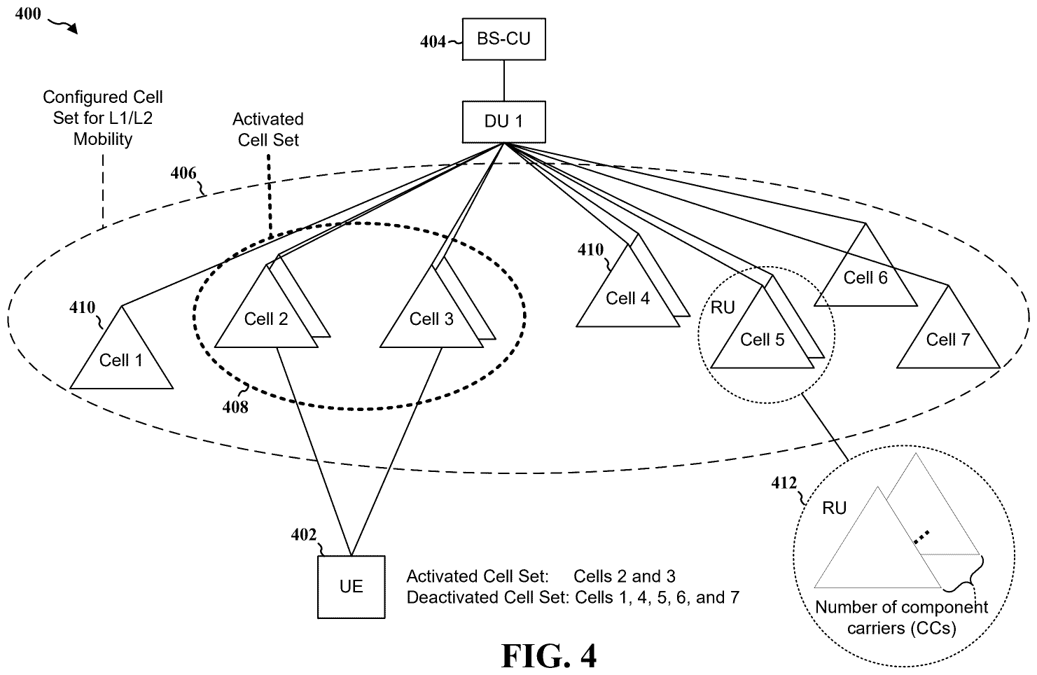

FIG. 4 is a diagram 400 illustrating an example inter-cell mobility of a UE in accordance with various aspects of the present disclosure. As a UE 402 moves from one location to another location, the UE 402 may be configured to perform layer one (L1) (e.g., physical layer) and/or layer two (L2) (e.g., medium access control (MAC) layer) based inter-cell mobility (which may also be referred to as “L1/L2 mobility” hereafter). Under inter-cell mobility, the UE 402 may be connected to a base station 404 (e.g., via a distributed unit (DU) of the base station 404), and the UE 402 may be handed over from one cell (or one group of cell) to another cell (or another group of cell) without implementing a radio resource control (RRC) anchor change (e.g., the UE 402 maintains its connection with the base station 404).

As shown at 406, for the UE 402 to perform the L1/L2 mobility, the base station 404 may configure the UE 402 with a set of cells (e.g., cells 1 to 7) via an RRC configuration, which may be referred to as an L1/L2 mobility configured cell set (or simply a configured cell set). Each cell with a configured cell set may be referred to as a configured cell. The L1/L2 mobility configured cell set may further include an L1/L2 mobility activated cell set (or simply an activated cell set) and an L1/L2 mobility deactivated cell set (or simply a deactivated cell set). As shown at 408, the activated cell set may refer to a group of cells (e.g., activated cells 2 and 4) in the configured cell set that are activated and can be readily used between the UE 402 and the base station 404 for data and control transfer. On the other hand, as shown at 410, the deactivated cell set may refer to a group of cells (e.g., deactivated cells 1, 4, 5, 6, and 7) in the configured cell set that are deactivated and can be readily activated (e.g., to become part of the activated cell set) by L1/L2 signaling (but may not be readily used for data and control transfer until activated). Cells in both the activated cell set and the deactivated cell set may be considered as serving cells under the L1/L2 mobility, and each cell may include multiple component carriers (CCs). The cells in the configured cell sets may belong to the same DU or different DUs. The base station 404 may continue to proactively configure the UE 402 with a new set of cells based on the UE 402's mobility via RRC signaling (e.g., by adding cell(s) to and/or removing cell(s) from the configured list of cells).

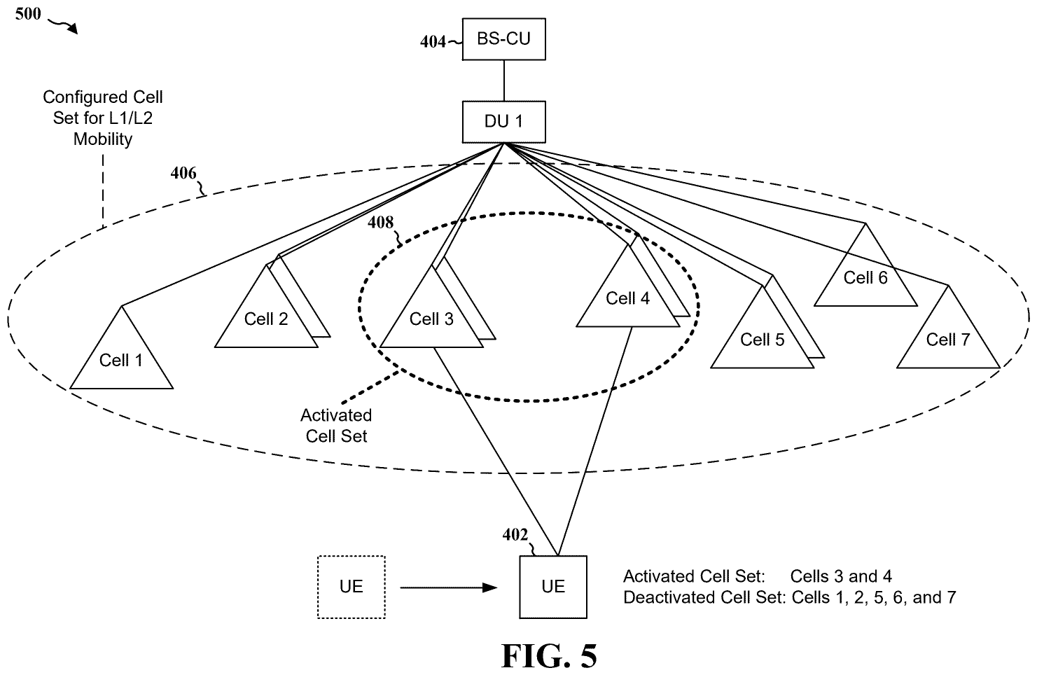

To facilitate seamless mobility within the cells in the activated cell set (which may be referred to as activated cells), L1/L2 signaling may be used between the UE 402 and the base station 404 to activate/deactivate cells in the configured cell set and to select beams within the activated cells. In other words, the mobility management of the activated cells sets and the deactivated cell sets may be based on L1/L2 signaling instead of layer three (L3) (e.g., the network layer, RRC) signaling as L1/L2 signaling generally takes less time to perform compared to the L3 signaling. As such, as the UE 402 moves, the cells from the configured cell set may be deactivated and activated via L1/L2 signaling. For example, as shown by a diagram 500 of FIG. 5, after the UE 402 moves to another location, cell 4 may be activated and cell 2 may be deactivated via L1/L2 signaling between the UE 402 and the base station 404.

In some example, the inter-cell mobility may be based on the signal quality (e.g., measurements such as reference signal received power (RSRP), signal to interference and noise ratio (SINR), etc.) and/or based on the loading of the cells. In some configurations, cells in the L1/L2 mobility configured cell set may belong to the same DU, which may be similar to carrier aggregation (CA) but the cells may be on the same carrier frequencies. In most implementations, the configured cell set configured for the UE 402 is large enough to cover a meaningful mobility area.

The UE 402 may be provided with a subset of deactivated cells (which may be referred to as a candidate cell set) in which the UE 402 may autonomously choose to add to the activated cell set, such as based on measured channel quality, the loading information, etc. For example, as shown by the diagram 400 of FIG. 4, the UE 402 may be provided with a deactivated cell set that includes deactivated cells 1, 4, 5, 6, and 7. Then, as shown by the diagram 500 of FIG. 5, as the UE 402 moves, the UE 402 may measure and determine that the channel quality for the activated cell 2 has dropped below a signal threshold or has a high traffic load (e.g., the number of users connected exceeds a traffic threshold). In response, the UE 402 may autonomously add the deactivated cell 4 to the activated cell set. In some examples, this may be similar to conditional handover for fast and efficient addition of the prepared cells.

Referring back to FIG. 4, as shown at 412, each of the RUs (e.g., the RUs 140 described in connection with FIG. 1) that is connected to the DU of the base station 404 may have multi-carrier (e.g., N CCs) support, where each CC is a cell. As such, activation/deactivation of cells may be done based on groups of carriers (e.g., cells).

To manage a primary cell (PCell), L1/L2 signaling may also be used by the UE 402 and the base station 404 to set a PCell out of one or more preconfigured options within the activated cell set. For some network, L3 mobility (e.g., L3 signaling) may be used for PCell change (e.g., L3 handover) when a new PCell is not from the activated cell set for L1/L2 mobility, where RRC signaling may be used for updating the set of cells for L1/L2 mobility at L3 handover. For purposes of the present disclosure, a special cell (SpCell/spCell/sPCell) may include a PCell or primary secondary cell(s) (PSCell) (e.g., SpCell=PCell or PSCell). Also, an activated cell may also be referred to as an active cell.

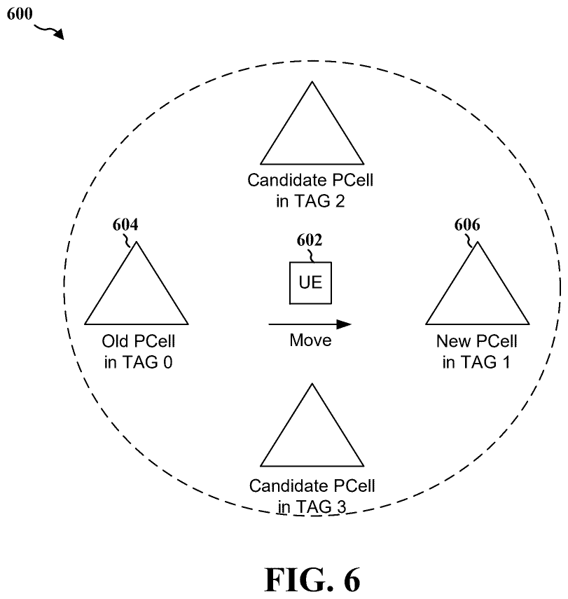

FIG. 6 is a diagram 600 illustrating an example of a UE being handed over from one PCell to another candidate PCell among a pre-configured candidate PCell set in accordance with various aspects of the present disclosure. A UE 602 may be configured with a set of candidate PCells by a base station, such as described in connection with FIGS. 4 and 5. In some examples, each PCell in the set of candidate PCells may further be associated with a timing advance group (TAG). For purposes of the present disclosure, a TAG may include one or more serving cells with the same uplink TA and the same downlink timing reference cell. Each TAG may contain at least one serving cell with configured uplink, and the mapping of each serving cell to a TAG may be configured by a base station via RRC. In addition, a deactivated TAG may refer to a TAG that just includes deactivated cells (e.g., without an activated/active cell), while an active TAG or an activated TAG may refer to a TAG that includes at least one activated/active cell.

As the UE 602 moves, the base station may handover the UE 602 from a current PCell 604, which may be associated with a first TAG (e.g., TAG 0) or a first TA, to a new PCell 606 among the set of deactivated candidate PCells, where the new PCell 606 may be associated with a second TAG (e.g., TAG 1) or a second TA. For example, the base station may request the UE 602 to measure the set of deactivated candidate PCells and report the measurement (e.g., via a CSI report) to the base station. Based on the measurement, the base station may determine which deactivated candidate PCell to handover the UE 602. In other words, for L1/L2 mobility, as a UE moves, a PCell may be reselected/updated among a set of pre-configured deactivated candidate PCells for the UE based on the UE's L1 measurement for those deactivated candidate PCells.

As such, some candidate deactivated PCells may not be activated before one of them is selected as the new PCell. For example, the new PCell 606 may not have been activated before it is selected as the new PCell. In some examples, in case that a TAG is assigned to each deactivated candidate PCell, there may be other cells sharing the same TAG. For example, candidate cells (e.g., PCell and SCells) in a candidate cell group may be associated with a physical cell site, where all candidate cells in the same TAG may be previously deactivated (e.g., all candidate cells sharing the TAG 1 as the new PCell 606 are not activated before handover).

Aspects presented herein may improve the latency and efficiency of L1/L2 inter-cell mobility by providing an improved timing advance (TA) management for a UE. In one aspect, when a UE is handed over from an activated PCell to a deactivated candidate PCell, it may be beneficial for the UE to maintain the TA on the deactivated candidate PCell to save or reduce the new PCell activation latency. For example, the UE may skip requesting a TA update after the deactivated candidate PCell is selected as the new PCell. For purposes of the present disclosure, a TA may refer to an offset or a time value in which a UE may apply to its uplink transmission, such that the uplink transmission is able to be synchronized with another transmission (e.g., a downlink transmission). For example, a UE may receive a TA command from a base station, where the TA command may request the UE to adjust its uplink transmission such that the UE sends uplink symbols in advance according to the TA command (e.g., for transmitting PUSCH, PUCCH and/or SRS transmissions, etc.). In other words, a TA command may inform the UE the amount of time that it is to advance the uplink transmissions.

In some network implementations, a UE may be configured not to transmit PRACH, sounding reference signal (SRS), and physical uplink control channel (PUCCH) on a deactivated PSCell/SCell, receive physical downlink control channel (PDCCH) on or for the deactivated PCell/SCell, and/or report CSI for the deactivated PCell/SCell. As such, the UE may not know the TA associated with the deactivated PSCell/SCell until the deactivated PSCell/SCell is activated. For example, referring back to FIG. 6, the UE 602 may not know the TA associated with the new PCell 606 before the UE 602 is connected to the new PCell 606 or before the UE 602 receives a TA update/command for the new PCell 606 from the base station. Thus, it may take some time for the UE 602 to receive and apply the TA associated with the new PCell 606 after the new PCell 606 is activated for the UE 602.

In one aspect of the present disclosure, to save or reduce the new PCell activation latency, a UE may be configured to maintain TA on a deactivated cell or a deactivated TAG, which may include a plurality of deactivated cells, such that the UE may apply the TA associated with the deactivated cell or the deactivated TAG prior to or when the deactivated cell or the deactivated TAG is activated. This may enable the UE to skip requesting/receiving a TA update/command for a new PCell after a deactivated candidate PCell is selected as the new PCell, thereby improving the latency and efficiency of L1/L2 inter-cell mobility. For example, a UE may be configured to maintain TA for a set of deactivated cells (e.g., one deactivated cell or a group of deactivated cells) without specifying any report and/or TA update/command from a serving base station, where the UE may derive the TA for a set of deactivated cell based on a reception (Rx) timing difference between an active cell and the set of deactivated cells. Then, the UE may apply the TA derived for the set of deactivated cells autonomously once the set of deactivated cells is activated. As the process of maintaining the TA for the set of deactivated cells does not specify additional signaling or reporting between the UE and the base station, the process of maintaining or updating the TA may also be referred to as a “report-less TA update.” For purposes of the present disclosure, the Rx timing difference may refer to a time difference between receiving a signal from a first wireless device (e.g., from a first cell) with respect to receiving a signal from a second wireless device (e.g., from a second cell).

In another example, a UE may be configured to report an Rx timing difference between different cells to a base station, and the base station may derive a TA for at least a deactivated cell and indicate the derived TA to the UE for the UE to apply. In other words, a TA may be computed by a base station based on UE report of Rx timing difference. In the context of L1/L2 mobility, a UE may report the Rx timing difference between active and deactivated cells, and a base station may compute the TA for the deactivated cell and signals the computed TA to the UE once the cell is activated. This process of maintaining or updating the TA may be referred to as a “report-based TA update.”

In one aspect, compared with the report-based TA update, the report-less TA update for deactivated cell(s) may include the following differences. In one example, there may be no dynamic signaling, or the amount of signaling may be reduced for the report-less TA update (e.g., no UL report and TA command, etc.). For example, it may be possible to update TA for a cell without any resource and/or report configurations. In another example, a base station may just provide semi-static information to a UE for the UE to derive the actual TA, such as a transmission (Tx) timing difference between two cells, UL-to-DL timing difference (e.g., the time difference between an uplink radio frame and the corresponding downlink radio frame) at each cell, etc. In another example, a set of rules may be specified at a UE to regulate the UE TA update period, where the set of rules may ensure that the TA is updated sufficiently frequent at the UE, in absence of reporting. In another example, one or more formats for a stored TA and/or an applied implicitly updated TA may be defined or configured at a UE. For example, unit of the TA may be specified for a UE when a TA is stored for a deactivated cell/TAG and applied upon an activation.

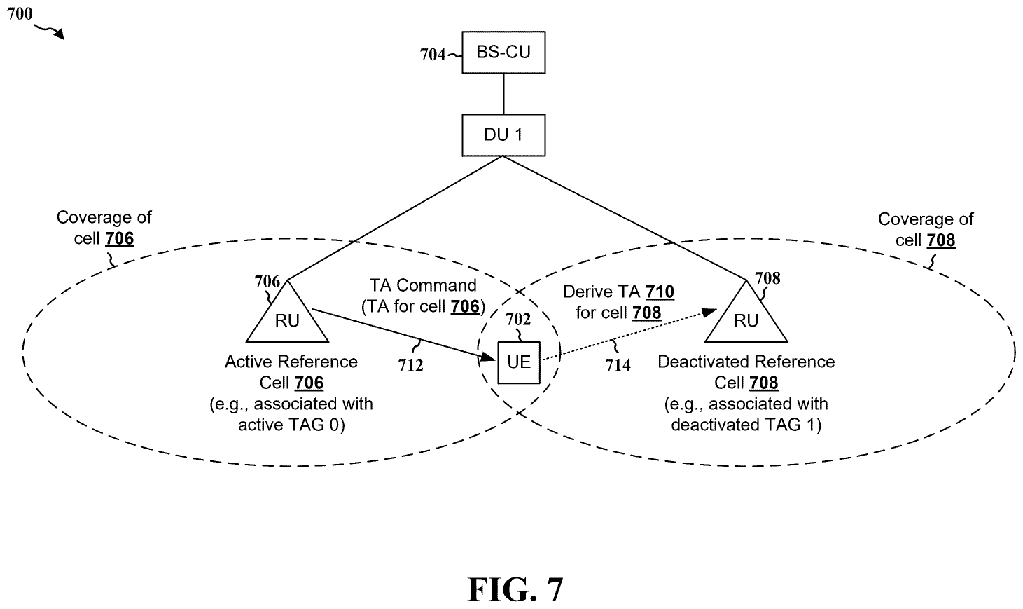

FIG. 7 is a diagram 700 illustrating an example of a UE deriving and maintaining a TA for a deactivated cell (which may be referred to as “implicit TA update”) based on an Rx time difference measurement in accordance with various aspects of the present disclosure. In one example, without transmitting physical random-access channel (PRACH) on a deactivated cell or a deactivated TAG, a UE may maintain the corresponding TA for the deactivated cell or the deactivated TAG by deriving the TA based on receiving the TA command from a reference active cell and calculating the Rx timing difference between the reference active cell and the set of deactivated cells in a pair of active and deactivated TAGs, respectively.

For example, for a UE 702 to perform L1/L2 mobility, a serving base station 704 may configure the UE 702 with an L1/L2 mobility configured cell set, where the L1/L2 mobility configured cell set may include at least an activated cell set (which may include an active cell 706) and a deactivated cell set (which may include a set of deactivated cells 708), such as described in connection with FIGS. 4 and 5. The activated cell set may refer to a group of cells in the L1/L2 mobility configured cell set that are activated and can be readily used between the UE 702 and the base station 704 for data and control transfer. On the other hand, the deactivated cell set may refer to a group of cells in the L1/L2 mobility configured cell set that are deactivated and can be readily activated (e.g., to become part of the active cell set) by L1/L2 signaling (but may not be readily used for data and control transfer until activated). Cells in both the activated cell set and the deactivated cell set may be considered as serving cells under the L1/L2 mobility, and each cell may include multiple CCs.

In one aspect, as shown at 714, the UE 702 may be configured to derive a TA 710 for the set of deactivated cells 708 based on an Rx time difference between the active cell 706 and the set of deactivated cells 708. For example, the UE 702 may receive synchronization signal block (SSBs) or reference signals (RSs) transmitted from the set of deactivated cells 708 and/or the active cell 706, and the UE 702 may derive the TA for the set of deactivated cells 708 based at least in part on the DL Rx timing and DL Tx timing for the active cell 706 and the set of deactivated cells 708. Then, the UE 702 may maintain the derived TA 710 for the set of deactivated cells 708 prior to an activation of the set of deactivated cells 708, and the UE 702 may apply the TA 710 to the set of deactivated cells 708 (when the set of deactivated cells 708 are not activated) and/or to an initial transmission to the set of deactivated cells 708 (after the set of deactivated cells 708 are activated) (discussed in details below). For purposes of the present disclosure, the set of deactivated cells 708 may include just one deactivated cell or multiple deactivated cells (e.g., a deactivated TAG).

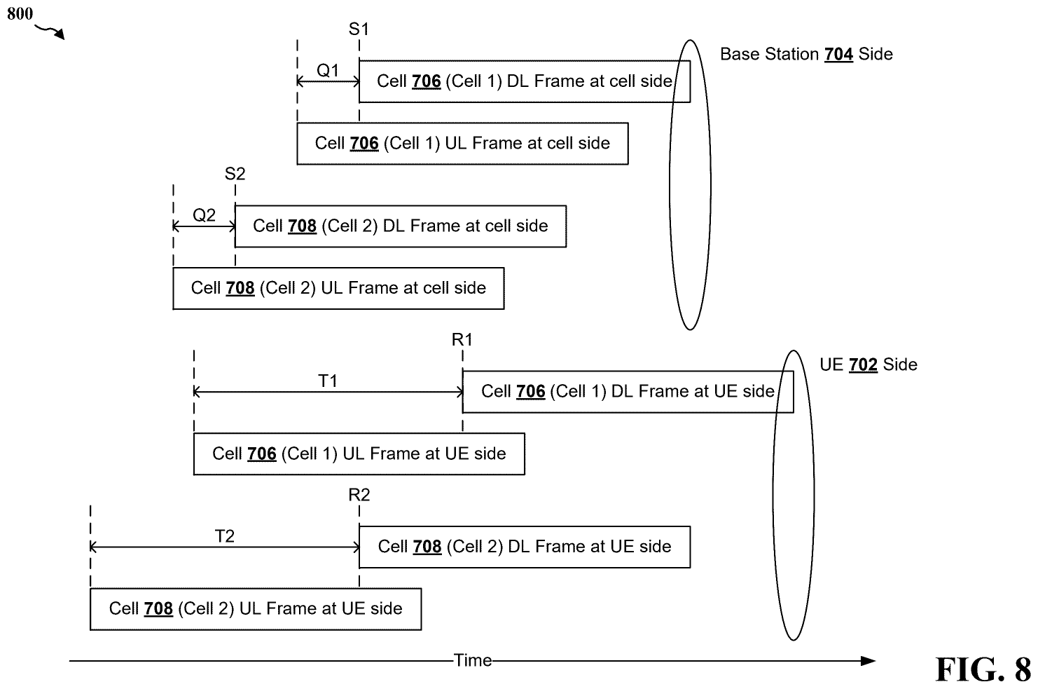

FIG. 8 is a diagram 800 illustrating an example of calculating a TA for a second cell (e.g., the set of deactivated cells 708) based on the TA from a first cell (e.g., the active cell 706) in accordance with various aspects of the present disclosure. As shown at 712 of FIG. 7, the UE 702 may receive the TA associated with the active cell 706 from the active cell 706, such as via a TA command. For purposes of illustration, the TA associated with the active cell 706 may be referred to as T1, and the TA 710 that is derived for the set of deactivated cells 708 may be referred to as T2.

In one aspect, referring to FIG. 8, the UE 702 may calculate the TA 710 (e.g., the T2) based on:

$$T 2 = T 1 - 2 * ( R 1 - R 2 ) + [ 2 * ( S 1 - S 2 ) - ( Q 1 - Q 2 ) ] ,$$

where T1 corresponds to the UE 702's TA for the active cell 706 (e.g., which can be signaled by the active cell 706 as shown at 712 of FIG. 7), R1 corresponds to the DL Rx timing for the active cell 706, R2 corresponds to the DL Rx timing for the set of deactivated cells 708, S1 corresponds to the DL Tx timing for the active cell 706, S2 corresponds to the DL Tx timing for the set of deactivated cells 708, Q1 corresponds to the UL and DL timing difference for the active cell 706, and Q2 corresponds to the UL and DL timing difference for the set of deactivated cells 708. In addition, the UE 702's UL transmission timing for the active cell 706 (which may be indicated as U1) and the UE 702's UL transmission timing for the set of deactivated cells 708 (which may be indicated as U2) may be defined as:

$$U 1 = R 1 - T 1 , U 2 = R 2 - T 2 , and \\ U 2 = R 2 - T 1 + 2 * ( R 1 - R 2 ) - [ 2 * ( S 1 - S 2 ) - ( Q 1 ‐ Q 2 ) ] .$$

In another aspect of the present disclosure, to ensure the quality and/or accuracy of the TA 710 (i.e., the implicitly updated TA quality) derived by the UE 702 for the set of deactivated cells 708, a set of specifications may be defined for and applied by the UE 702. For example, a specification may be defined at the UE 702 such that the applied metric by the UE 702 is capable of achieving certain accuracy or accuracy threshold compared with an ideal value metric. The applied metric related to the UE 702 applying the TA 710 (i.e., the implict TA update) may include following cases.

In the first case (e.g., case 1), the UE 702 may derive and maintain the TA 710 (e.g., T2) or the UL transmission timing (e.g., U2) for the set of deactivated cells 708 prior to the activation of the set of deactivated cells 708, such that the UE 702 may apply the TA 710 to UL Tx to the set of deactivated cells 708 once the set of deactivated cells 708 is activated. In other words, TA or UL transmission timing is applied to the deactivated cell/TAG to prepare UL Tx once activated. In this case, the UE 702 may still adjust the UL Tx timing although no UL Tx happens.

In the second case (e.g., case 2), the UE 702 may derive, maintain, and apply the TA 710 (e.g., T2) or the UL transmission timing (e.g., U2) to an initial UL Tx to the set of deactivated cells 708 after the set of deactivated cells 708 is activated. In other words, TA or UL transmission timing is applied to the initial UL Tx on newly activated cell/TAG. The initial UL Tx to the set of deactivated cells 708 may include at least those cells to which the TA may be applied. In one example, the UE 702 may be configured to derive and apply the TA 710 or the UL transmission timing to an initial UL Tx (e.g., to apply case 2) if at least one SSB is available at the UE 702 during a defined period, such as during the last X ms (e.g., X=160). In other words, if the UE 702 is able to receive at least one SSB from the set of deactivated cells 708 before a defined period (e.g., X ms), the UE 702 may derive and apply the TA 710 or the UL transmission timing (e.g., U2) to an initial UL Tx to the set of deactivated cells 708 after the set of deactivated cells 708 is activated. This may reduce TA processing and maintenance at the UE 702 compared to the case 1.

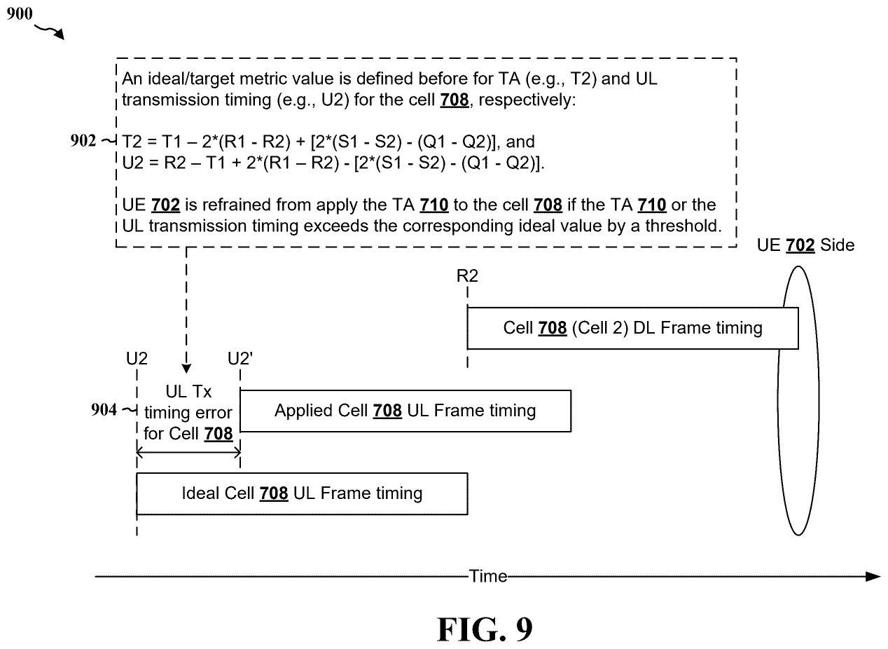

FIG. 9 is a diagram 900 illustrating an example of a UE maintaining an ideal/target metric value for TA and/or UL transmission timing for a set of deactivated cells (e.g., the set of deactivated cells 708) to ensure the quality and/or accuracy of the TA (e.g., the TA 710) and/or the UL transmission timing derived for the set of deactivated cells are accurate within a threshold in accordance with various aspects of the present disclosure.

For example, as shown at 902, the UE 702 may be configured to maintain or calculate an ideal or target metric value for the TA (e.g., T2) and/or the UL transmission timing (e.g., U2) for the set of deactivated cells 708, such as based on:

$$T 2 = T 1 - 2 * ( R 1 - R 2 ) + [ 2 * ( S 1 - S 2 ) - ( Q 1 - Q 2 ) ] , and \\ U 2 = R 2 - T 1 + 2 * ( R 1 - R 2 ) - [ 2 * ( S 1 - S 2 ) - ( Q 1 - Q 2 ) ] .$$

Then, if the TA 710 or the UL transmission timing derived by the UE 702 for the set of deactivated cells 708 (denoted by T2′ and U2′, respectively, for this example) exceeds a defined threshold or timing accuracy specification (e.g., exceeds an UL Tx timing error defined for the set of deactivated cells 708 as shown at 904), the UE 702 may be refrained from applying the derived TA 710 (T2′) or the UL transmission timing (U2′) to the set of deactivated cells 708.

In one aspect, the timing accuracy specification (e.g., the defined threshold) in which the UE 702 is to meet (in order for the UE 702 to apply the maintained TA 710) may be represented in the form of plus-minus (±) X*64*Tc, where X may be fixed or depend on one or more factors and Tc may be a time unit (e.g., Tc=0.509 nanoseconds (ns)). For example, the one or more factors may include the frequency range in which the UE 702 is communicating with the base station 704, where a first value may be assigned to X if the UE 702 is communicating under frequency range FR1, a second value may be assigned to X if the UE 702 is communicating under frequency range FR2-1, and a third value may be assigned to X if the UE 702 is communicating under frequency range FR2-2, etc.

In another example, the one or more factors may include the DL SCS of DL RS or DL active/configured BWP configured for the UE 702. If the UE 702 is configured to maintain the TA 710 for the set of deactivated cells 708 prior to the activation of the set of deactivated cells 708 (e.g., case 1 is applied), the DL SCS may include SCS of DL RS(s) of one or both the active cell 706 and the set of deactivated cells 708 that is used by the UE 702 for the DL Tx timing difference measurement. On the other hand, if the UE 702 is configured to derive and apply the TA 710 to an initial UL Tx to the set of deactivated cells 708 after the set of deactivated cells 708 is activated (e.g., case 2 is applied), the DL SCS may be the SCS of an SSB or an active DL BWP of set of deactivated cells 708 after activation (i.e., the newly activated cell/TAG).

In another example, the one or more factors may include the UL SCS of UL channel/RS or UL active/configured BWP configured for the UE 702. If the UE 702 is configured to maintain the TA 710 for the set of deactivated cells 708 prior to the activation of the set of deactivated cells 708 (e.g., case 1 is applied), the UL SCS may be the largest SCS of all configured UL BWPs across cell(s) to which the TA 710 is applied. On the other hand, if the UE 702 is configured to derive and apply the TA 710 to an initial UL Tx to the set of deactivated cells 708 after the set of deactivated cells 708 is activated (e.g., case 2 is applied), the UL SCS may be the SCS of the initial UL Tx to the set of deactivated cells 708 (e.g., to the newly activated cell/TAG).

In another example, the one or more factors may include the link quality (e.g., L1-RSRP and/or SINR) between the UE 702 and the cell(s). If the UE 702 is configured to maintain the TA 710 for the set of deactivated cells 708 prior to the activation of the set of deactivated cells 708 (e.g., case 1 is applied), the link quality may include the quality of DL RS(s) of one or both the active cell 706 and the set of deactivated cells 708 that is used by the UE 702 for the DL Tx timing difference measurement. On the other hand, if the UE 702 is configured to derive and apply the TA 710 to an initial UL Tx to the set of deactivated cells 708 after the set of deactivated cells 708 is activated (e.g., case 2 is applied), the link quality may include the quality of the SSB of the set of deactivated cells 708 (e.g., to the newly activated cell/TAG).

In another aspect of the present disclosure, if the TA 710 derived/maintained by the UE 702 is unable to meet or satisfy the timing accuracy specification (e.g., the defined threshold), in one example, the UE 702 may be configured to gradually adjust the applied TA 710 or the UL Tx timing until the timing accuracy specification is met/satisfied. In addition, the gradual adjustment may have the following parameters (whose values may also depend on the frequency range and/or UL SCS): a maximum amount of the magnitude of the timing change in one adjustment (e.g., 1 ms, 2 ms, etc.), a minimum aggregated adjustment rate per second, a maximum aggregated adjustment rate per a defined period (e.g., per X ms), or a combination thereof. In another example, the UE 702 may be configured to perform a one-time adjustment to the TA 710 to satisfy the timing accuracy specification (e.g., the defined threshold), where the UE 702 may skip applying the TA 710 to the set of deactivated cells 708. In some examples, such one-time adjustment may subject to the capability of the UE 702, frequency range in which the UE 702 is communicating, and/or the power class of the UE 702, etc.

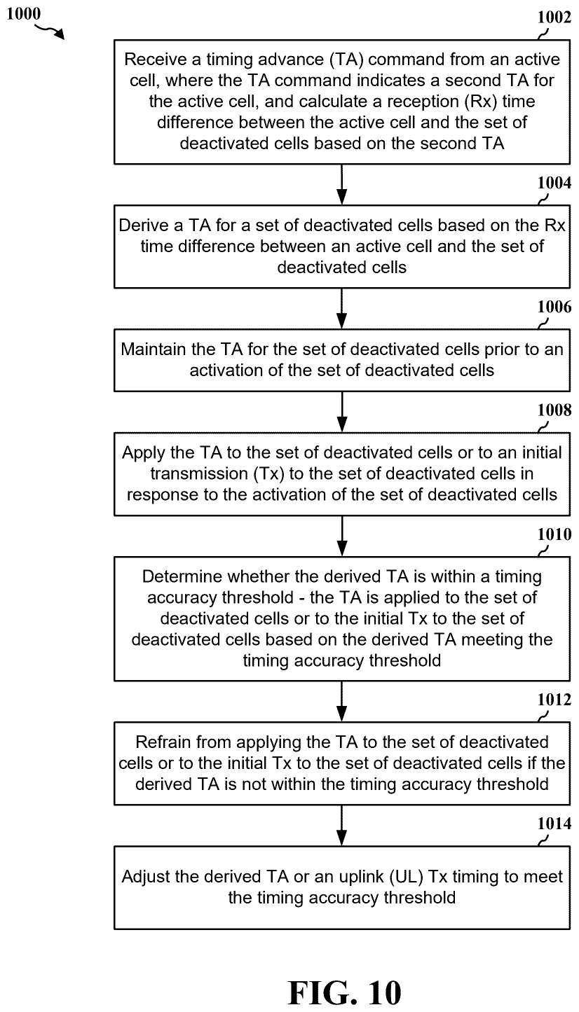

FIG. 10 is a flowchart 1000 of a method of wireless communication. The method may be performed by a UE (e.g., the UE 104, 402, 602, 702; the apparatus 1204). The method may enable the UE to maintain TA on a set of deactivated candidate PCell to save or reduce the new PCell activation latency.

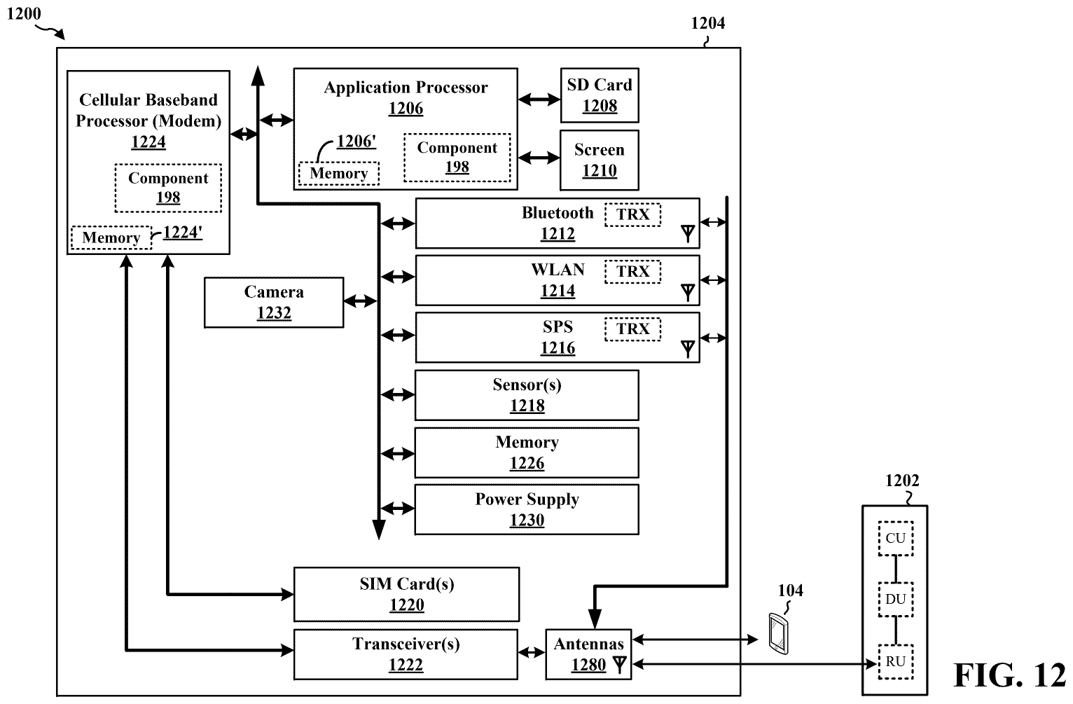

At 1002, the UE may receive a TA command from an active cell, where the TA command indicates a second TA for the active cell, and the UE may calculate an Rx time difference between the active cell and the set of deactivated cells based on the second TA, such as described in connection with FIGS. 7 and 8. For example, at 712, the UE 702 may receive a TA command from the active cell 706 that includes the TA for the active cell 706, and the UE 702 may calculate an Rx time difference between the active cell 706 and the set of deactivated cells 708 based on the TA for the active cell 706. The reception of the TA command and/or the calculation of the Rx time difference may be performed by, e.g., the TA derivation component 198, the cellular baseband processor 1224, and/or the transceiver(s) 1222 of the apparatus 1204 in FIG. 12.

In one example, the TA for the set of deactivated cells is derived based on: T2=T1−2*(R1−R2)+[2*(S1−S2)−(Q1−Q2)], where T2 corresponds to the TA, T1 corresponds to the second TA, R1 corresponds to a first downlink (DL) Rx timing for the active cell, R2 corresponds to a second DL Rx timing for the set of deactivated cells, S1 corresponds to a first DL Tx timing for the active cell, S2 corresponds to a second DL Tx timing for the set of deactivated cells, Q1 corresponds to a first UL and DL timing difference for the active cell, and Q2 corresponds to a second UL and DL timing difference for the set of deactivated cells. In such an example, a first UL transmission timing (U1) for the active cell is determined based on: U1=R1−T1. In such an example, a second UL transmission timing (U2) for the set of deactivated cells is determined based on: U2=R2−T2; or U2=R2−T1+2*(R1−R2)−[2*(S1−S2)−(Q1−Q2)].

At 1004, the UE may derive a TA for a set of deactivated cells based on the Rx time difference between the active cell and the set of deactivated cells, such as described in connection with FIGS. 7 and 8. For example, at 714, the UE 702 may derive a TA 710 for a set of deactivated cells 708 based on the Rx time difference between the active cell 706 and the set of deactivated cells 708. The derivation of the TA for the set of deactivated cells may be performed by, e.g., the TA derivation component 198, the cellular baseband processor 1224, and/or the transceiver(s) 1222 of the apparatus 1204 in FIG. 12.

In one example, the set of deactivated cells corresponds to one deactivated cell or a deactivated TAG that includes multiple deactivated cells.

In another example, the UE may receive, from a network node, at least one of a Tx timing difference between the active cell and the set of deactivated cells or an UL-to-DL timing difference for each of the active cell and the set of deactivated cells, where the TA for the set of deactivated cells is further derived based on the Tx timing difference or the UL-to-DL timing difference.

At 1006, the UE may maintain the TA for the set of deactivated cells prior to an activation of the set of deactivated cells, such as described in connection with FIGS. 7 and 8. For example, the UE 702 may maintain the TA 710 for the set of deactivated cells 708 prior to an activation of the set of deactivated cells 708. The maintenance of the TA may be performed by, e.g., the TA derivation component 198, the cellular baseband processor 1224, and/or the transceiver(s) 1222 of the apparatus 1204 in FIG. 12.

At 1008, the UE may apply the TA to the set of deactivated cells or to an initial Tx to the set of deactivated cells in response to the activation of the set of deactivated cells, such as described in connection with FIGS. 7 and 8. For example, the UE 702 may apply the TA 710 to the set of deactivated cells 708 or to an initial Tx to the set of deactivated cells 708 in response to the activation of the set of deactivated cells 708. The application of the TA to the set of deactivated cells or to an initial Tx to the set of deactivated cells may be performed by, e.g., the TA derivation component 198, the cellular baseband processor 1224, and/or the transceiver(s) 1222 of the apparatus 1204 in FIG. 12.

In one example, at 1010, the UE may determine whether the derived TA is within a timing accuracy threshold, where the TA is applied to the set of deactivated cells or to the initial Tx to the set of deactivated cells based on the derived TA meeting the timing accuracy threshold, such as described in connection with FIGS. 7 to 9. For example, the UE 702 may determine whether the derived TA 710 is within a timing accuracy threshold, and the UE 702 may apply the TA 710 to the set of deactivated cells 708 or to the initial Tx to the set of deactivated cells 708 if the TA 710 meets the timing accuracy threshold. The determination of whether the derived TA is within a timing accuracy threshold may be performed by, e.g., the TA derivation component 198, the cellular baseband processor 1224, and/or the transceiver(s) 1222 of the apparatus 1204 in FIG. 12. In such an example, a value of the timing accuracy threshold is determined based on at least one of: a frequency range for communicating with the active cell or the set of deactivated cells after the activation, a DL SCS of a DL RS or a DL active or configured BWP for the active cell or the set of deactivated cells after the activation, an UL SCS of an UL channel or an UL RS or a UL active or configured BWP for communicating with the active cell or the set of deactivated cells after the activation, or a link quality associated with the active cell, the set of deactivated cells before the activation, or the set of deactivated cells after the activation

At 1012, the UE may refrain from applying the TA to the set of deactivated cells or to the initial Tx to the set of deactivated cells if the derived TA is not within the timing accuracy threshold, such as described in connection with FIGS. 7 to 9. For example, the UE 702 may refrain from applying the TA 710 to the set of deactivated cells 708 or to the initial Tx to the set of deactivated cells 708 if the derived TA 710 is not within the timing accuracy threshold. The refraining from applying the TA may be performed by, e.g., the TA derivation component 198, the cellular baseband processor 1224, and/or the transceiver(s) 1222 of the apparatus 1204 in FIG. 12.

At 1014, the UE may adjust the derived TA or an UL Tx timing to meet the timing accuracy threshold, such as described in connection with FIGS. 7 to 9. For example, the UE 702 may adjust the derived TA 710 or an UL Tx timing (gradually or one-time) to meet the timing accuracy threshold. The adjustment of the derived TA or the UL Tx timing may be performed by, e.g., the TA derivation component 198, the cellular baseband processor 1224, and/or the transceiver(s) 1222 of the apparatus 1204 in FIG. 12.

In one example, the derived TA is adjusted gradually until the timing accuracy threshold is met. In such an example, the derived TA is adjusted gradually based on at least one of: a maximum amount of a magnitude of a timing change in one adjustment, a minimum aggregate adjustment rate per second, or a maximum aggregate adjustment rate for a defined period.

In another example, the derived TA is adjusted one time to meet the timing accuracy threshold. In such an example, the derived TA is adjusted based on at least one of: a capability of the UE, a frequency range for communicating with the active cell or the set of deactivated cells after the activation, or a power class associated with the UE.

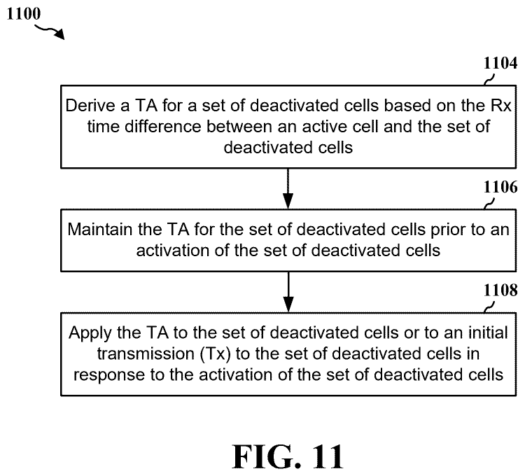

FIG. 11 is a flowchart 1100 of a method of wireless communication. The method may be performed by a UE (e.g., the UE 104, 402, 602, 702; the apparatus 1204). The method may enable the UE to maintain TA on a set of deactivated candidate PCell to save or reduce the new PCell activation latency.

At 1104, the UE may derive a TA for a set of deactivated cells based on the Rx time difference between the active cell and the set of deactivated cells, such as described in connection with FIGS. 7 and 8. For example, at 714, the UE 702 may derive a TA 710 for a set of deactivated cells 708 based on the Rx time difference between the active cell 706 and the set of deactivated cells 708. The derivation of the TA for the set of deactivated cells may be performed by, e.g., the TA derivation component 198, the cellular baseband processor 1224, and/or the transceiver(s) 1222 of the apparatus 1204 in FIG. 12.

In one example, the set of deactivated cells corresponds to one deactivated cell or a deactivated TAG that includes multiple deactivated cells.

In another example, the UE may receive, from a network node, at least one of a Tx timing difference between the active cell and the set of deactivated cells or an UL-to-DL timing difference for each of the active cell and the set of deactivated cells, where the TA for the set of deactivated cells is further derived based on the Tx timing difference or the UL-to-DL timing difference.

In another example, the UE may receive a TA command from an active cell, where the TA command indicates a second TA for the active cell, and the UE may calculate an Rx time difference between the active cell and the set of deactivated cells based on the second TA, such as described in connection with FIGS. 7 and 8. For example, at 712, the UE 702 may receive a TA command from the active cell 706 that includes the TA for the active cell 706, and the UE 702 may calculate an Rx time difference between the active cell 706 and the set of deactivated cells 708 based on the TA for the active cell 706. The reception of the TA command and/or the calculation of the Rx time difference may be performed by, e.g., the TA derivation component 198, the cellular baseband processor 1224, and/or the transceiver(s) 1222 of the apparatus 1204 in FIG. 12. In such an example, the TA for the set of deactivated cells is derived based on: T2=T1−2*(R1−R2)+[2*(S1−S2)−(Q1−Q2)], where T2 corresponds to the TA, T1 corresponds to the second TA, R1 corresponds to a first downlink (DL) Rx timing for the active cell, R2 corresponds to a second DL Rx timing for the set of deactivated cells, S1 corresponds to a first DL Tx timing for the active cell, S2 corresponds to a second DL Tx timing for the set of deactivated cells, Q1 corresponds to a first UL and DL timing difference for the active cell, and Q2 corresponds to a second UL and DL timing difference for the set of deactivated cells. In such an example, a first UL transmission timing (U1) for the active cell is determined based on: U1=R1-T1. In such an example, a second UL transmission timing (U2) for the set of deactivated cells is determined based on: U2=R2−T2; or U2=R2−T1+2*(R1−R2)−[2*(S1−S2)−(Q1−Q2)].

At 1106, the UE may maintain the TA for the set of deactivated cells prior to an activation of the set of deactivated cells, such as described in connection with FIGS. 7 and 8. For example, the UE 702 may maintain the TA 710 for the set of deactivated cells 708 prior to an activation of the set of deactivated cells 708. The maintenance of the TA may be performed by, e.g., the TA derivation component 198, the cellular baseband processor 1224, and/or the transceiver(s) 1222 of the apparatus 1204 in FIG. 12.

At 1108, the UE may apply the TA to the set of deactivated cells or to an initial Tx to the set of deactivated cells in response to the activation of the set of deactivated cells, such as described in connection with FIGS. 7 and 8. For example, the UE 702 may apply the TA 710 to the set of deactivated cells 708 or to an initial Tx to the set of deactivated cells 708 in response to the activation of the set of deactivated cells 708. The application of the TA to the set of deactivated cells or to an initial Tx to the set of deactivated cells may be performed by, e.g., the TA derivation component 198, the cellular baseband processor 1224, and/or the transceiver(s) 1222 of the apparatus 1204 in FIG. 12.

In one example, the UE may determine whether the derived TA is within a timing accuracy threshold, where the TA is applied to the set of deactivated cells or to the initial Tx to the set of deactivated cells based on the derived TA meeting the timing accuracy threshold, such as described in connection with FIGS. 7 to 9. For example, the UE 702 may determine whether the derived TA 710 is within a timing accuracy threshold, and the UE 702 may apply the TA 710 to the set of deactivated cells 708 or to the initial Tx to the set of deactivated cells 708 if the TA 710 meets the timing accuracy threshold. The determination of whether the derived TA is within a timing accuracy threshold may be performed by, e.g., the TA derivation component 198, the cellular baseband processor 1224, and/or the transceiver(s) 1222 of the apparatus 1204 in FIG. 12. In such an example, a value of the timing accuracy threshold is determined based on at least one of: a frequency range for communicating with the active cell or the set of deactivated cells after the activation, a DL SCS of a DL RS or a DL active or configured BWP for the active cell or the set of deactivated cells after the activation, an UL SCS of an UL channel or an UL RS or a UL active or configured BWP for communicating with the active cell or the set of deactivated cells after the activation, or a link quality associated with the active cell, the set of deactivated cells before the activation, or the set of deactivated cells after the activation

In another example, the UE may refrain from applying the TA to the set of deactivated cells or to the initial Tx to the set of deactivated cells if the derived TA is not within the timing accuracy threshold, such as described in connection with FIGS. 7 to 9. For example, the UE 702 may refrain from applying the TA 710 to the set of deactivated cells 708 or to the initial Tx to the set of deactivated cells 708 if the derived TA 710 is not within the timing accuracy threshold. The refraining from applying the TA may be performed by, e.g., the TA derivation component 198, the cellular baseband processor 1224, and/or the transceiver(s) 1222 of the apparatus 1204 in FIG. 12.

In another example, the UE may adjust the derived TA or an UL Tx timing to meet the timing accuracy threshold, such as described in connection with FIGS. 7 to 9. For example, the UE 702 may adjust the derived TA 710 or an UL Tx timing (gradually or one-time) to meet the timing accuracy threshold. The adjustment of the derived TA or the UL Tx timing may be performed by, e.g., the TA derivation component 198, the cellular baseband processor 1224, and/or the transceiver(s) 1222 of the apparatus 1204 in FIG. 12. In one example, the derived TA is adjusted gradually until the timing accuracy threshold is met. In such an example, the derived TA is adjusted gradually based on at least one of: a maximum amount of a magnitude of a timing change in one adjustment, a minimum aggregate adjustment rate per second, or a maximum aggregate adjustment rate for a defined period. In another example, the derived TA is adjusted one time to meet the timing accuracy threshold. In such an example, the derived TA is adjusted based on at least one of: a capability of the UE, a frequency range for communicating with the active cell or the set of deactivated cells after the activation, or a power class associated with the UE.

FIG. 12 is a diagram 1200 illustrating an example of a hardware implementation for an apparatus 1204. The apparatus 1204 may be a UE, a component of a UE, or may implement UE functionality. In some aspects, the apparatus 1204 may include a cellular baseband processor 1224 (also referred to as a modem) coupled to one or more transceivers 1222 (e.g., cellular RF transceiver). The cellular baseband processor 1224 may include on-chip memory 1224′. In some aspects, the apparatus 1204 may further include one or more subscriber identity modules (SIM) cards 1220 and an application processor 1206 coupled to a secure digital (SD) card 1208 and a screen 1210. The application processor 1206 may include on-chip memory 1206′. In some aspects, the apparatus 1204 may further include a Bluetooth module 1212, a WLAN module 1214, an SPS module 1216 (e.g., GNSS module), one or more sensor modules 1218 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1226, a power supply 1230, and/or a camera 1232. The Bluetooth module 1212, the WLAN module 1214, and the SPS module 1216 may include an on-chip transceiver (TRX) (or in some cases, just a receiver (RX)). The Bluetooth module 1212, the WLAN module 1214, and the SPS module 1216 may include their own dedicated antennas and/or utilize the antennas 1280 for communication. The cellular baseband processor 1224 communicates through the transceiver(s) 1222 via one or more antennas 1280 with the UE 104 and/or with an RU associated with a network entity 1202. The cellular baseband processor 1224 and the application processor 1206 may each include a computer-readable medium/memory 1224′, 1206′, respectively. The additional memory modules 1226 may also be considered a computer-readable medium/memory. Each computer-readable medium/memory 1224′, 1206′, 1226 may be non-transitory. The cellular baseband processor 1224 and the application processor 1206 are each responsible for general processing, including the execution of software stored on the computer-readable medium/memory. The software, when executed by the cellular baseband processor 1224/application processor 1206, causes the cellular baseband processor 1224/application processor 1206 to perform the various functions described supra. The computer-readable medium/memory may also be used for storing data that is manipulated by the cellular baseband processor 1224/application processor 1206 when executing software. The cellular baseband processor 1224/application processor 1206 may be a component of the UE 350 and may include the memory 360 and/or at least one of the TX processor 368, the RX processor 356, and the controller/processor 359. In one configuration, the apparatus 1204 may be a processor chip (modem and/or application) and include just the cellular baseband processor 1224 and/or the application processor 1206, and in another configuration, the apparatus 1204 may be the entire UE (e.g., see 350 of FIG. 3) and include the additional modules of the apparatus 1204.

As discussed supra, the TA derivation component 198 is configured to derive a TA for a set of deactivated cells based on an Rx time difference between an active cell and the set of deactivated cells. The TA derivation component 198 may also be configured to maintain the TA for the set of deactivated cells prior to an activation of the set of deactivated cells. The TA derivation component 198 may also be configured to apply the TA to the set of deactivated cells or to an initial Tx to the set of deactivated cells in response to the activation of the set of deactivated cells. The TA derivation component 198 may be within the cellular baseband processor 1224, the application processor 1206, or both the cellular baseband processor 1224 and the application processor 1206. The TA derivation component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1204 may include a variety of components configured for various functions. In one configuration, the apparatus 1204, and in particular the cellular baseband processor 1224 and/or the application processor 1206, includes means for deriving a TA for a set of deactivated cells based on an Rx time difference between an active cell and the set of deactivated cells. The apparatus 1204 may further include means for maintaining the TA for the set of deactivated cells prior to an activation of the set of deactivated cells. The apparatus 1204 may further include means for applying the TA to the set of deactivated cells or to an initial Tx to the set of deactivated cells in response to the activation of the set of deactivated cells.

In one configuration, the set of deactivated cells corresponds to one deactivated cell or a deactivated TAG that includes multiple deactivated cells.

In another configuration, the apparatus 1204 may further include means for receiving, from a network node, at least one of a Tx timing difference between the active cell and the set of deactivated cells or an UL-to-DL timing difference for each of the active cell and the set of deactivated cells, where the TA for the set of deactivated cells is further derived based on the Tx timing difference or the UL-to-DL timing difference.

In another configuration, the apparatus 1204 may further include means for receiving a TA command from an active cell, where the TA command indicates a second TA for the active cell, and means for calculating an Rx time difference between the active cell and the set of deactivated cells based on the second TA. In such a configuration, the TA for the set of deactivated cells is derived based on: T2=T1−2*(R1−R2)+[2*(S1−S2)−(Q1−Q2)], where T2 corresponds to the TA, T1 corresponds to the second TA, R1 corresponds to a first downlink (DL) Rx timing for the active cell, R2 corresponds to a second DL Rx timing for the set of deactivated cells, S1 corresponds to a first DL Tx timing for the active cell, S2 corresponds to a second DL Tx timing for the set of deactivated cells, Q1 corresponds to a first UL and DL timing difference for the active cell, and Q2 corresponds to a second UL and DL timing difference for the set of deactivated cells. In such a configuration, a first UL transmission timing (U1) for the active cell is determined based on: U1=R1−T1. In such a configuration, a second UL transmission timing (U2) for the set of deactivated cells is determined based on: U2=R2−T2; or U2=R2−T1+2*(R1−R2)−[2*(S1−S2)−(Q1−Q2)].

In another configuration, the apparatus 1204 may further include means for determining whether the derived TA is within a timing accuracy threshold, where the TA is applied to the set of deactivated cells or to the initial Tx to the set of deactivated cells based on the derived TA meeting the timing accuracy threshold. In such a configuration, a value of the timing accuracy threshold is determined based on at least one of: a frequency range for communicating with the active cell or the set of deactivated cells after the activation, a DL SCS of a DL RS or a DL active or configured BWP for the active cell or the set of deactivated cells after the activation, an UL SCS of an UL channel or an UL RS or a UL active or configured BWP for communicating with the active cell or the set of deactivated cells after the activation, or a link quality associated with the active cell, the set of deactivated cells before the activation, or the set of deactivated cells after the activation

In another configuration, the apparatus 1204 may further include means for refraining from applying the TA to the set of deactivated cells or to the initial Tx to the set of deactivated cells if the derived TA is not within the timing accuracy threshold.

In another configuration, the apparatus 1204 may further include means for adjusting the derived TA or an UL Tx timing to meet the timing accuracy threshold. In one configuration, the derived TA is adjusted gradually until the timing accuracy threshold is met. In such a configuration, the derived TA is adjusted gradually based on at least one of: a maximum amount of a magnitude of a timing change in one adjustment, a minimum aggregate adjustment rate per second, or a maximum aggregate adjustment rate for a defined period. In another configuration, the derived TA is adjusted one time to meet the timing accuracy threshold. In such a configuration, the derived TA is adjusted based on at least one of: a capability of the UE, a frequency range for communicating with the active cell or the set of deactivated cells after the activation, or a power class associated with the UE.

The means may be the TA derivation component 198 of the apparatus 1204 configured to perform the functions recited by the means. As described supra, the apparatus 1204 may include the TX processor 368, the RX processor 356, and the controller/processor 359. As such, in one configuration, the means may be the TX processor 368, the RX processor 356, and/or the controller/processor 359 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE, including: deriving a TA for a set of deactivated cells based on an Rx time difference between an active cell and the set of deactivated cells; maintaining the TA for the set of deactivated cells prior to an activation of the set of deactivated cells; and applying the TA to the set of deactivated cells or to an initial Tx to the set of deactivated cells in response to the activation of the set of deactivated cells.

Aspect 2 is the method of aspect 1, where the set of deactivated cells corresponds to one deactivated cell or a deactivated TAG that includes multiple deactivated cells.

Aspect 3 is the method of any of aspects 1 or 2, further including: receiving, from a network node, at least one of a Tx timing difference between the active cell and the set of deactivated cells or an uplink UL-to-DL timing difference for each of the active cell and the set of deactivated cells, where the TA for the set of deactivated cells is further derived based on the Tx timing difference or the UL-to-DL timing difference.

Aspect 4 is the method of any of aspects 1 to 3, further including: receiving a TA command from the active cell, where the TA command indicates a second TA for the active cell; and calculating the Rx time difference between the active cell and the set of deactivated cells based on the second TA.

Aspect 5 is the method of aspect 4, where the TA for the set of deactivated cells is derived based on: T2=T1−2*(R1−R2)+[2*(S1−S2)−(Q1−Q2)], where T2 corresponds to the TA, T1 corresponds to the second TA, R1 corresponds to a first downlink (DL) Rx timing for the active cell, R2 corresponds to a second DL Rx timing for the set of deactivated cells, S1 corresponds to a first DL Tx timing for the active cell, S2 corresponds to a second DL Tx timing for the set of deactivated cells, Q1 corresponds to a first UL and DL timing difference for the active cell, and Q2 corresponds to a second UL and DL timing difference for the set of deactivated cells.

Aspect 6 is the method of aspect 5, where a first UL transmission timing (U1) for the active cell is determined based on: U1=R1−T1.

Aspect 7 is the method of aspect 6, where a second UL transmission timing (U2) for the set of deactivated cells is determined based on: U2=R2−T2; or U2=R2−T1+2*(R1−R2)−[2*(S1−S2)−(Q1−Q2)].

Aspect 8 is the method of any of aspects 1 to 7, further including: determining whether the derived TA is within a timing accuracy threshold, where the TA is applied to the set of deactivated cells or to the initial Tx to the set of deactivated cells based on the derived TA meeting the timing accuracy threshold.

Aspect 9 is the method of aspect 8, where a value of the timing accuracy threshold is determined based on at least one of: a frequency range for communicating with the active cell or the set of deactivated cells after the activation, a DL SCS of a DL RS or a DL active or configured BWP for the active cell or the set of deactivated cells after the activation, an UL SCS of an UL channel or an UL RS or a UL active or configured BWP for communicating with the active cell or the set of deactivated cells after the activation, or a link quality associated with the active cell, the set of deactivated cells before the activation, or the set of deactivated cells after the activation.

Aspect 10 is the method of aspect 8, further including: refraining from applying the TA to the set of deactivated cells or to the initial Tx to the set of deactivated cells if the derived TA is not within the timing accuracy threshold.

Aspect 11 is the method of aspect 10, further including: adjusting the derived TA or an UL Tx timing to meet the timing accuracy threshold.

Aspect 12 is the method of aspect 11, where the derived TA is adjusted gradually until the timing accuracy threshold is met.

Aspect 13 is the method of aspect 12, where derived TA is adjusted gradually based on at least one of: a maximum amount of a magnitude of a timing change in one adjustment, a minimum aggregate adjustment rate per second, or a maximum aggregate adjustment rate for a defined period.

Aspect 14 is the method of aspect 11, where the derived TA is adjusted one time to meet the timing accuracy threshold.

Aspect 15 is the method of aspect 14, where the derived TA is adjusted based on at least one of: a capability of the UE, a frequency range for communicating with the active cell or the set of deactivated cells after the activation, or a power class associated with the UE.

Aspect 16 is an apparatus for wireless communication at a UE, including: a memory; and at least one processor coupled to the memory and, based at least in part on information stored in the memory, the at least one processor is configured to implement any of aspects 1 to 15.

Aspect 17 is the apparatus of aspect 16, further including at least one of a transceiver or an antenna coupled to the at least one processor.

Aspect 18 is an apparatus for wireless communication including means for implementing any of aspects 1 to 15.

Aspect 19 is a computer-readable medium (e.g., a non-transitory computer-readable medium) storing computer executable code, where the code when executed by a processor causes the processor to implement any of aspects 1 to 15.

What is claimed is:

1. An apparatus for wireless communication at a user equipment (UE), comprising:
a memory; and
at least one processor coupled to the memory and, based at least in part on information stored in the memory, the at least one processor is configured to:
derive a timing advance (TA) for a set of deactivated cells based on a reception (Rx) time difference between an active cell and the set of deactivated cells;
maintain the TA for the set of deactivated cells prior to an activation of the set of deactivated cells; and
apply the TA to the set of deactivated cells or to an initial transmission (Tx) to the set of deactivated cells in response to the activation of the set of deactivated cells.

2. The apparatus of claim 1, wherein the set of deactivated cells corresponds to one deactivated cell or a deactivated timing advance group (TAG) that includes multiple deactivated cells.

3. The apparatus of claim 1, wherein the at least one processor is further configured to:
receive, from a network node, at least one of a Tx timing difference between the active cell and the set of deactivated cells or an uplink (UL)-to-(DL) (UL-to-DL) timing difference for each of the active cell and the set of deactivated cells, wherein the TA for the set of deactivated cells is further derived based on the Tx timing difference or the UL-to-DL timing difference.

4. The apparatus of claim 1, wherein the at least one processor is further configured to:
receive a TA command from the active cell, wherein the TA command indicates a second TA for the active cell; and
calculate the Rx time difference between the active cell and the set of deactivated cells based on the second TA.

5. The apparatus of claim 4, wherein the TA for the set of deactivated cells is derived based on: T2=T1−2*(R1−R2)+[2*(S1−S2)−(Q1−Q2)], where T2 corresponds to the TA, T1 corresponds to the second TA, R1 corresponds to a first downlink (DL) Rx timing for the active cell, R2 corresponds to a second DL Rx timing for the set of deactivated cells, S1 corresponds to a first DL Tx timing for the active cell, S2 corresponds to a second DL Tx timing for the set of deactivated cells, Q1 corresponds to a first UL and DL timing difference for the active cell, and Q2 corresponds to a second UL and DL timing difference for the set of deactivated cells.

6. The apparatus of claim 5, wherein a first UL transmission timing (U1) for the active cell is determined based on: U1=R1−T1.

7. The apparatus of claim 6, wherein a second UL transmission timing (U2) for the set of deactivated cells is determined based on: U2=R2−T2; or U2=R2−T1+2*(R1−R2)−[2*(S1−S2)−(Q1−Q2)].

8. The apparatus of claim 1, wherein the at least one processor is further configured to:
determine whether the derived TA is within a timing accuracy threshold, wherein the TA is applied to the set of deactivated cells or to the initial Tx to the set of deactivated cells based on the derived TA meeting the timing accuracy threshold.

9. The apparatus of claim 8, wherein a value of the timing accuracy threshold is determined based on at least one of:
a frequency range for communicating with the active cell or the set of deactivated cells after the activation,
a downlink (DL) subcarrier spacing (SCS) of a DL reference signal (RS) or a DL active or configured bandwidth part (BWP) for the active cell or the set of deactivated cells after the activation,
an uplink (UL) SCS of an UL channel or an UL RS or a UL active or configured BWP for communicating with the active cell or the set of deactivated cells after the activation, or
a link quality associated with the active cell, the set of deactivated cells before the activation, or the set of deactivated cells after the activation.

10. The apparatus of claim 8, wherein the at least one processor is further configured to:
refrain from applying the TA to the set of deactivated cells or to the initial Tx to the set of deactivated cells if the derived TA is not within the timing accuracy threshold.

11. The apparatus of claim 10, wherein the at least one processor is further configured to:
adjust the derived TA or an uplink (UL) Tx timing to meet the timing accuracy threshold.

12. The apparatus of claim 11, wherein the derived TA is adjusted gradually until the timing accuracy threshold is met.

13. The apparatus of claim 12, wherein derived TA is adjusted gradually based on at least one of:
a maximum amount of a magnitude of a timing change in one adjustment,
a minimum aggregate adjustment rate per second, or
a maximum aggregate adjustment rate for a defined period.

14. The apparatus of claim 11, wherein the derived TA is adjusted one time to meet the timing accuracy threshold.

15. The apparatus of claim 14, wherein the derived TA is adjusted based on at least one of:
a capability of the UE,
a frequency range for communicating with the active cell or the set of deactivated cells after the activation, or
a power class associated with the UE.

16. A method of wireless communication at a user equipment (UE), comprising:
deriving a timing advance (TA) for a set of deactivated cells based on a reception (Rx) time difference between an active cell and the set of deactivated cells;
maintaining the TA for the set of deactivated cells prior to an activation of the set of deactivated cells; and
applying the TA to the set of deactivated cells or to an initial transmission (Tx) to the set of deactivated cells in response to the activation of the set of deactivated cells.

17. The method of claim 16, wherein the set of deactivated cells corresponds to one deactivated cell or a deactivated timing advance group (TAG) that includes multiple deactivated cells.

18. The method of claim 16, further comprising:
receiving, from a network node, at least one of a Tx timing difference between the active cell and the set of deactivated cells or an uplink (UL)-to-(DL) (UL-to-DL) timing difference for each of the active cell and the set of deactivated cells, wherein the TA for the set of deactivated cells is further derived based on the Tx timing difference or the UL-to-DL timing difference.

19. The method of claim 16, further comprising:
receiving a TA command from the active cell, wherein the TA command indicates a second TA for the active cell; and
calculating the Rx time difference between the active cell and the set of deactivated cells based on the second TA.

20. The method of claim 19, wherein the TA for the set of deactivated cells is derived based on: T2=T1−2*(R1−R2)+[2*(S1−S2)−(Q1−Q2)], where T2 corresponds to the TA, T1 corresponds to the second TA, R1 corresponds to a first downlink (DL) Rx timing for the active cell, R2 corresponds to a second DL Rx timing for the set of deactivated cells, S1 corresponds to a first DL Tx timing for the active cell, S2 corresponds to a second DL Tx timing for the set of deactivated cells, Q1 corresponds to a first UL and DL timing difference for the active cell, and Q2 corresponds to a second UL and DL timing difference for the set of deactivated cells.

21. The method of claim 20, wherein a first UL transmission timing (U1) for the active cell is determined based on: U1=R1−T1, and a second UL transmission timing (U2) for the set of deactivated cells is determined based on: U2=R2−T2; or U2=R2−T1+2*(R1−R2)−[2*(S1−S2)−(Q1−Q2)].

22. The method of claim 16, further comprising:
determining whether the derived TA is within a timing accuracy threshold, wherein the TA is applied to the set of deactivated cells or to the initial Tx to the set of deactivated cells based on the derived TA meeting the timing accuracy threshold.

23. The method of claim 22, wherein a value of the timing accuracy threshold is determined based on at least one of:
a frequency range for communicating with the active cell or the set of deactivated cells after the activation,
a downlink (DL) subcarrier spacing (SCS) of a DL reference signal (RS) or a DL active or configured bandwidth part (BWP) for the active cell or the set of deactivated cells after the activation,
an uplink (UL) SCS of an UL channel or an UL RS or a UL active or configured BWP for communicating with the active cell or the set of deactivated cells after the activation, or
a link quality associated with the active cell, the set of deactivated cells before the activation, or the set of deactivated cells after the activation.

24. The method of claim 22, further comprising:
refraining from applying the TA to the set of deactivated cells or to the initial Tx to the set of deactivated cells if the derived TA is not within the timing accuracy threshold.

25. The method of claim 24, further comprising:
adjusting the derived TA or an uplink (UL) Tx timing to meet the timing accuracy threshold.

26. The method of claim 25, wherein the derived TA is adjusted gradually until the timing accuracy threshold is met or the derived TA is adjusted one time to meet the timing accuracy threshold.

27. The method of claim 26, wherein derived TA is adjusted gradually based on at least one of:
a maximum amount of a magnitude of a timing change in one adjustment,
a minimum aggregate adjustment rate per second, or
a maximum aggregate adjustment rate for a defined period.

28. The method of claim 26, wherein the derived TA is adjusted based on at least one of:
a capability of the UE,
a frequency range for communicating with the active cell or the set of deactivated cells after the activation, or
a power class associated with the UE.

29. An apparatus for wireless communication at a user equipment (UE), comprising:
means for deriving a timing advance (TA) for a set of deactivated cells based on a reception (Rx) time difference between an active cell and the set of deactivated cells;
means for maintaining the TA for the set of deactivated cells prior to an activation of the set of deactivated cells; and
means for applying the TA to the set of deactivated cells or to an initial transmission (Tx) to the set of deactivated cells in response to the activation of the set of deactivated cells.

30. A computer-readable medium storing computer executable code at a user equipment (UE), the code when executed by a processor causes the processor to:
derive a timing advance (TA) for a set of deactivated cells based on a reception (Rx) time difference between an active cell and the set of deactivated cells;
maintain the TA for the set of deactivated cells prior to an activation of the set of deactivated cells; and
apply the TA to the set of deactivated cells or to an initial transmission (Tx) to the set of deactivated cells in response to the activation of the set of deactivated cells.
